(19) United States
(12) Patent Application Publication
(10) Pub. No.: US 2007/0074529 A1
(43) Pub. Date: Apr. 5, 2007

(54) Refrigerator and water tank for the same

(75) Inventor: Seung-tae Lim, Gwangju-city (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/528,348

(22) Filed: Sep. 28, 2006

(30) Foreign Application Priority Data
Sep. 28, 2005 (KR) 10-2005-0090692

(51) Int. Cl. B67D 5/62; F25D 11/00

(52) U.S. Cl. 62/389; 62/440

(57) ABSTRACT

A refrigerator, which stores water supplied from a water supply source, having: a water tank body with an inlet disposed at a bottom of the water tank body and connected with the water supply source, and an outlet, disposed at a top of the water tank body, communicating with a water dispenser of the refrigerator, and communicating with the inlet through a flow channel; and a bypass pipe having a bypass flow channel communicating with a top end of the water tank body and the outlet. A flow channel of the water tank body and the bypass flow channel are branched from each other at 90 degrees or less.

CROSS-REFERENCE TO RELATED APPLICATIONS

This application claims the benefit of Korean Patent Application No. 2005-0090692, filed on Sep. 28, 2005, in the Korean Intellectual Property Office, the disclosure of which is incorporated herein by reference.

### BACKGROUND OF THE INVENTION

1. Field of the Invention

The present invention relates to a refrigerator and a water tank for the same, and more particularly, to a refrigerator and a water tank for the same for promptly discharging air and increasing effects of first-in-first-out for water.

2. Description of the Related Art

Generally, a refrigerator has a body having a storage chamber storing articles such as food and drink, a door opening and closing an opening formed in the storage chamber of the body, and a freezing device that is provided in the body to refrigerate the storage chamber. Recent refrigerators have not only an original function that temporarily keeps or stores food and drink, but also various functions that correspond to various demands of a user. For example, recent refrigerators have a dispenser for supplying ice, cold or hot water, and so on to a user.

Korean Patent No. 10-402622 discloses a refrigerator having such a dispenser. According to this invention, the refrigerator has a water supply pipe supplying water to the refrigerator, a water valve receiving water from a water source, a pipe that is connected to one side of the water valve to transfer water from the water valve, and a water tank that is connected to the pipe to store water. The water tank includes a body that has a zigzag shape upward and downward and is formed with an inlet introducing water at one side of an upper part thereof and an outlet for discharging water at the other side of the upper part, and a bypass pipe that communicates with a top area of the zigzag shaped body and the outlet. Further, the water tank is disposed so that it is cooled by cold air generated from an evaporator. Further, the conventional refrigerator has the dispenser that is connected to the other side of the water tank by a pipe and is formed in the front side of the refrigerator. From the above configuration, water supplied from the water source through the water supply pipe is stored in the water tank after passing through the water valve and the pipe. Then, water stored within the water tank is cooled and then is discharged to the dispenser to supply cold water to a user.

Referring to FIG. 6, however, in the conventional refrigerator, since the flow of water that flows along the zigzag shape after entering the water tank is different from the flow of water that flows along the bypass pipe, that is, since each flow of water that flows from the inlet to the zigzag passage a and to the bypass passage b is radically branched at an angle of 90° or more at the cross point of the both passages, the whirlpool may be partially generated. This whirlpool makes discharge of air difficult by whirling around air introduced into the water tank round and keeping air within the water tank. The air that is not discharged from the water tank is compressed by high hydraulic pressure and then, if the water valve is closed, is expanded to have the same atmospheric pressure as the pressure of a water outlet of the dispenser, thereby generating rest water in the water outlet of the dispenser. That is, water is still dispensed from the dispenser even though the dispenser is not employed by a user, thereby causing problems such as sanitation, cleaning, and so on.

Further, in the conventional refrigerator, water that is firstly introduced into the water tank is kept in a cold state. Then, if water having a room temperature is introduced thereafter through the bypass pipe and is mixed with the cold water, a first-in-first-out dispensation is prevented, thereby causing the supply of water to have a relatively higher temperature.

### SUMMARY

Accordingly, it is an aspect of the present invention to provide a refrigerator and a water tank for the same for promptly discharging air and enhancing effects of first-in- first-out for water.

According to an aspect of the present invention, there is provided a refrigerator, which stores water supplied from a water supply source, having: a water tank body comprising an inlet connected with the water supply source, and an outlet communicating with a water dispenser of the refrigerator, and communicating with the inlet through a flow channel; and a bypass pipe having a bypass flow channel communicating with a top end of the water tank body and the outlet, wherein a flow channel of the water tank body and the bypass flow channel are branched from each other at 90 degrees or less.

According to an aspect of the invention, the flow channel of the water tank body is zigzagged upward and downward.

According to an aspect of the invention, the inlet and the outlet communicate with the lower part of the water tank body and with the upper part of the water tank body, respectively, and are disposed to face each other with respect to the flow channel of the water tank body.

According to one aspect, the bypass flow channel is upwardly inclined toward the outlet.

According to one aspect, the bypass flow channel has a relatively small cross-sectional area as compared with the flow channel of the water tank body.

According to one aspect, the cross-sectional area of the bypass flow channel is gradually reduced going toward the outlet.

According to another aspect of the present invention, there is provided a refrigerator comprising a water tank that stores water supplied from a water supply source, the water tank having: a water tank body having an inlet connected to the water supply source, the inlet being disposed in a lower part of the water tank body, and a flow channel that is zigzagged upward and downward; a bypass pipe having a bypass flow channel that communicates with a top end of the water tank body and is disposed to face flow from the inlet; and a branching area where water supplied from the water supply source is branched from the zigzag flow channel of the water tank body to the bypass flow channel, wherein the angle between the zigzag flow channel of the water tank body and the bypass flow channel in the branching area is an acute angle.

According to one aspect, the water tank body has an outlet disposed in an upper part thereof to communicate with the water tank body and a water dispenser of the refrigerator.

According to one aspect, the inlet and the outlet are disposed on a same lateral side of the water tank body.

According to one aspect, the bypass flow channel is upwardly inclined toward the outlet.

According to one aspect, the bypass flow channel has a relatively small cross-sectional area as compared with a cross-sectional area of the flow channel of the water tank body.

According to one aspect, the cross-sectional area of the bypass flow channel is gradually reduced going toward the outlet.

According to another aspect of the present invention, there is provided a water tank for a refrigerator, which stores water supplied from a water supply source, the water tank having: a water tank body with an inlet connected with the water supply source and an outlet communicating with the inlet through a flow channel that is zigzagged upward and downward and also communicating with a water dispenser of the refrigerator; and a bypass pipe having a bypass flow channel communicating with a top end of the water tank body and the outlet, wherein the flow channel of the water tank body and the bypass flow channel are branched from each other at 90 degrees or less.

According to one aspect, the inlet and the outlet communicate with the lower part of the water tank body and with the upper part of the water tank body, respectively, and are disposed to face each other with respect to the flow channel of the water tank body.

According to one aspect, the bypass flow channel is upwardly inclined toward the outlet.

According to one aspect, the bypass flow channel has a relatively small cross-sectional area as compared with a cross-sectional area of the flow channel of the water tank body.

According to one aspect, the cross-sectional area of the bypass flow channel is gradually reduced going toward the outlet.

According to another aspect of the present invention, there is provided a water tank for a refrigerator, which stores water supplied from a water supply source, the water tank having: a water tank body including an inlet disposed at a lower part of the water tank body and connected with the water supply source, and an outlet disposed at an upper part of the water tank body and communicating with the inlet through a flow channel that is zigzagged upward and downward, and also communicating with a water dispenser of the refrigerator; and a bypass pipe having a bypass flow channel communicating with a top end of the water tank body and the outlet, wherein a cross-sectional area of the bypass flow channel is gradually reduced going toward the outlet.

According to another aspect of the present invention, there is provided a water tank for a refrigerator, which stores water supplied from a water supply source, the water tank having: a water tank body including an inlet disposed at a lower part of the water tank body and connected with the water supply source, and an outlet disposed at an upper part of the water tank body and communicating with the inlet through a flow channel that is zigzagged upward and downward, and also communicating with a water dispenser of the refrigerator; and a bypass pipe having a bypass flow channel communicating with a top end of the water tank body and the outlet, wherein the inlet and the outlet are disposed on a same lateral side of the water tank body.

Additional and/or other aspects and advantages of the present invention will be set forth in part in the description that follows and, in part, will be apparent from the description, or may be learned by practice of the invention.

### BRIEF DESCRIPTION OF THE DRAWINGS

The above and/or other aspects and advantages of the prevent invention will become apparent and more readily appreciated from the following detailed description, taken in conjunction with the accompany drawings, of which:

FIG. 1 is a perspective view showing a flow of water supplied to a refrigerator according to an embodiment of the present invention;

FIG. 2 is a front view of a water tank;

FIG. 3 is a left side view of the water tank of FIG. 2;

FIG. 4 is an enlarged view of a bypass pipe;

FIG. 5 is a schematic view showing the flow of water within the water tank of FIG. 2; and

FIG. 6 is a schematic view showing the flow of water in a conventional refrigerator.

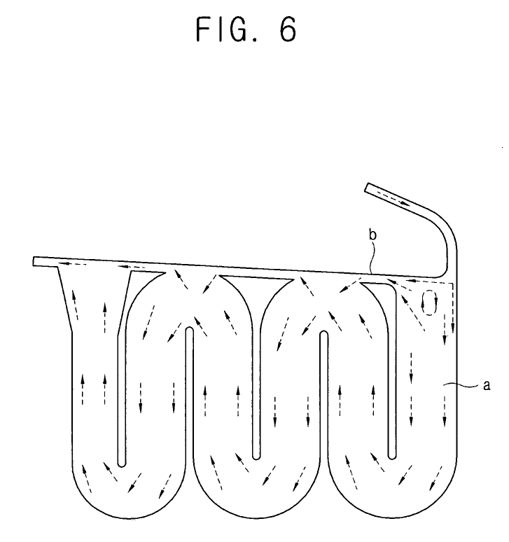

### DETAILED DESCRIPTION

Reference will now be made in detail to the embodiments of the present invention, examples of which are illustrated in the accompanying drawings, wherein like reference numerals refer to like elements throughout. The embodiments are described below so as to explain the present invention by referring to the figures.

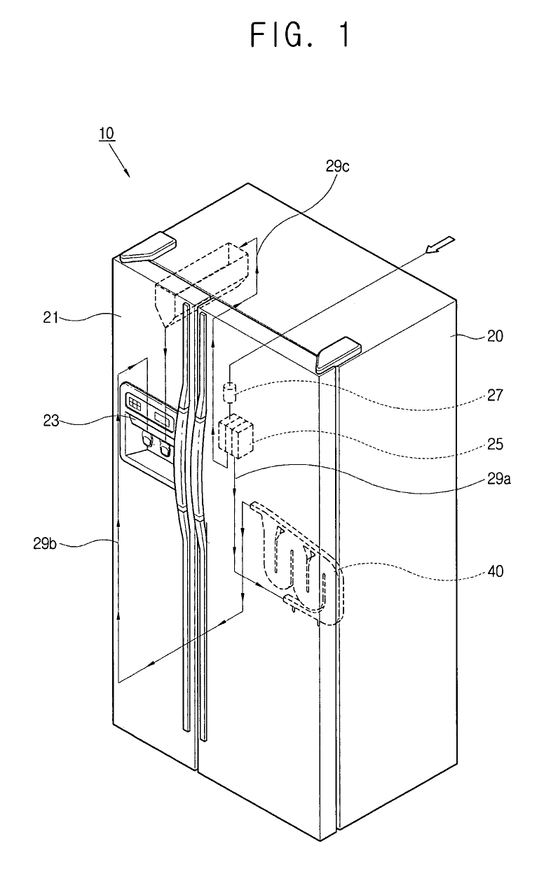

An embodiment of the present invention relates to a water tank 40 for a refrigerator and a refrigerator 10 having a water tank. The refrigerator 10 having the water tank 40, as shown in FIG. 1, includes a body that has a door opening and is formed with a storage chamber (not shown), a door 21 opening and closing the door opening, and a water dispenser 23 that is provided in the door 21. Further, the refrigerator 10 includes a water tank body 50 having a zigzag flow channel 51 and 53 that comprises a vertical part 51 and a reversing part 53 and is zigzagged upward and downward, an inlet 60 introducing water in a lower part of water tank body 50 and an outlet 65 supplying water to the water dispenser 23 disposed in an upper part of water tank body 50; and a bypass pipe 80 communicating a top end of reversing part 53 to the outlet 65. A flow channel of the water tank body 50 and the bypass pipe 80 are branched from each other 90 degrees or less. Further, the refrigerator 10 has freezing devices such as an evaporator and a compressor, which are not shown.

The body 20, as shown in FIG. 1, has the door opening in the front side of the refrigerator 10 and the storage chamber such as a cooling chamber or a freezing chamber that is not shown.

The door 21, as shown in FIG. 1, opens and closes the door opening that is in the front side of the refrigerator 10. Further, the door 21 may be provided singly or plurally. Further, the door 21 has the water dispenser 23 for supplying cold water, hot water, and ice.

The water dispenser 23, which is provided in the door 21, as shown in FIG. 1, supplies ice, cold water, hot water, and so on to the user. The process for supplying water to the water dispenser 23 will be described later.

The water tank 40, as shown in FIGS. 1 to 3, includes the water tank body 50 that has the flow channel zigzagged upward and downward and is formed with the inlet 60 introducing water in the lower part of water tank body 50 and the outlet 65 supplying water to the water dispenser 23 in an upper part of water tank body 50, and the bypass pipe 80 communicating the top end of reversing part 53 of the zigzag flow channel 51 and 53 of the water tank body 50 to the outlet 65. According to one embodiment, the water tank 40 is installed on a rear side of the cooling chamber, so that the water tank 40 can exchange heat with the cold air generated from the evaporator to supply cold water having a predetermined temperature.

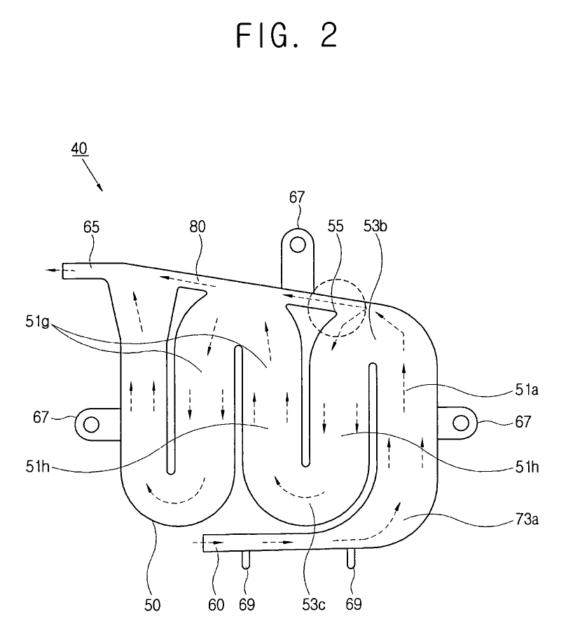

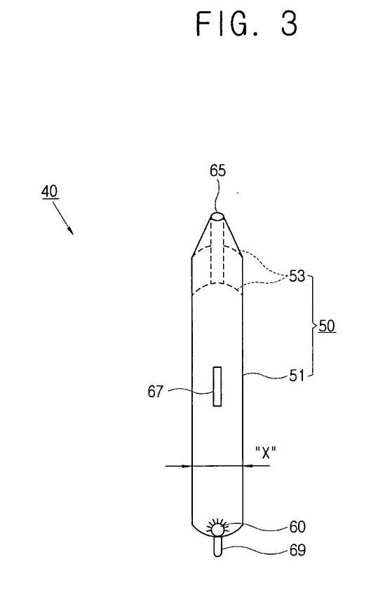

The water tank body 50, as shown in FIGS. 2 and 3, has the flow channel that is zigzagged upward and downward. Further, the water tank body 50 is formed with the inlet 60 introducing water at the lower part of water tank body 50 and the outlet 65, disposed at the upper part of water tank body 50 to supply water to the dispenser 23. The top end of the reversing part 53 of the water tank body 50 communicates with the outlet 65 by the bypass pipe 80. The flow channel of the water tank body 50 and the bypass pipe 80 are branched from each other 90 degrees or less. Thus, air, which is lighter than water generated by water supply, is promptly discharged in the top end of the water tank body 50. Further, the water tank body 50 has a square section when viewing in the front and rear directions of the water tank 40 in FIG. 2 and has an elliptical section when viewing in the side direction of the water tank 40 in FIG. 2. Alternatively, the water tank body 50 may have various shapes such as an elliptical shape or the like, as necessary.

The zigzag flow channels 51 and 53 have at least one vertical part 51 that has a shape of a hollow column and at least one curved reversing part 53 causing the vertical pipes 51 to communicate with each other in a zigzag shape to store and guide water. The zigzag flow channel 51 and 53 and the bypass pipe 80 of the water tank body 50 are branched from each other at 90 degrees or less at a branching area 55.

The vertical parts 51, as shown in FIG. 2, are disposed in parallel upward and downward so that the water tank body 50 has a zigzag shape upward and downward. Further, the vertical part 51 has a square section to maximize a utility of a predetermined space to increase heat exchange area as soon as possible. But according to one embodiment, the vertical part 51 may have various shapes such as an elliptical shape and so on, as necessary. Further, the vertical part 51 serves to store water and to guide the flow of water by communicating with the reversing parts 53.

The reversing parts 53, as shown in FIG. 3, have a curved shape so that they cause the vertical parts 51 to communicate with each other, thereby allowing the water tank body 50 to have a zigzag shape upward and downward. Further, the reversing parts 53 cause the top ends 51g (refer to FIG. 2) of the vertical parts 51 to communicate with each other and the bottom ends 51h in FIG. 2 of the vertical parts 51 to communicate with each other so that water within the water tank body 50 may flow along the zigzag flow channels 51 and 53. Further, according to one embodiment, the reversing parts 53 communicate with the outlet 65 and the inlet 60, respectively. According to one embodiment, reversing part 53 has a square shape to communicate with the vertical part 51. According to another embodiment, reversing part 53 various other shapes, such as an elliptical shape or the like, as necessary.

The branching area 55, as shown in FIG. 2, is a part where the flow channel of the water tank body 50 and the bypass pipe 80 are branched from each other at 90 degrees or less. Thus, air may be discharged promptly from the water tank 40 during the water supply process, since a whirlpool or the like is not generated. An angle smaller than 90 degrees is more preferable.

The inlet 60, as shown in FIGS. 2 and 3, is provided in the lower part of the water tank body 50 and introduces water into the water tank body 50. Further, the inlet 60 is connected to the reversing part 53 of the water tank body 50 to maintain a smooth flow of water. Thus, air generated from the water supply process is promptly discharged to the upper part. Further, the inlet 60 is provided on the same lateral side of water tank body 50 as the outlet 65, to form a relatively long flow channel by the zigzag flow channels 51 and 53, thereby increasing the surface area for heat exchange.

The outlet 65, as shown in FIGS. 2 and 3, is disposed in the upper part of the water tank body 50 to supply water to the water dispenser 23. Further, the outlet 65 communicates with the top end of the reversing parts 53 of the water tank body 50 and the bypass pipe 80. Further, the outlet 65 is disposed in an upwardly inclined direction, thereby promptly discharging air from the water tank 40 while supplying water.

Further, when the bypass pipe 80 is branched from the zigzag flow channels 51 and 53, since the branched angle is 90° or less, a whirlpool is not formed at the branched portion. Thus, air generated while supplying water is promptly discharged and not trapped in water tank 40 by a whirlpool.

Referring to FIG. 2, a plurality of brackets 67 are attached to the outer sides of the water tank body 50 to secure the water tank 40 in the refrigerator 10.

Additionally, according to one embodiment, a predetermined number of pins 69, as shown in FIGS. 2 and 3, are projected from the bottom end of the water tank body 50 to easily couple the water tank 40 to the refrigerator 10.

Thus, since the water tank 40 is provided with the inlet 60 in the lower part thereof and the outlet 65 in the upper part thereof, there is no interference between the introduced water and the water that flows along the zigzag flow channels 51 and 53 of the water tank body 50, a whirlpool is not generated. Further, the water tank 40 is formed with the upward and downward zigzagged flow channels 51 and 53. Thus, the surface area is increased within a predetermined limited space and the water stays in the water tank 40 longer, whereby efficient heat exchange is performed and the capacity of the water tank 40 is increased by maximizing the space utilization.

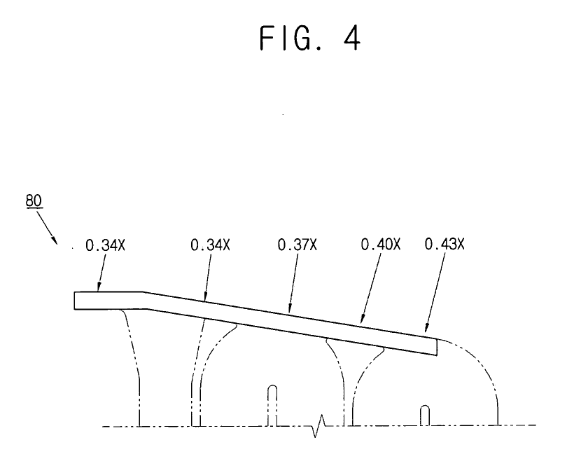

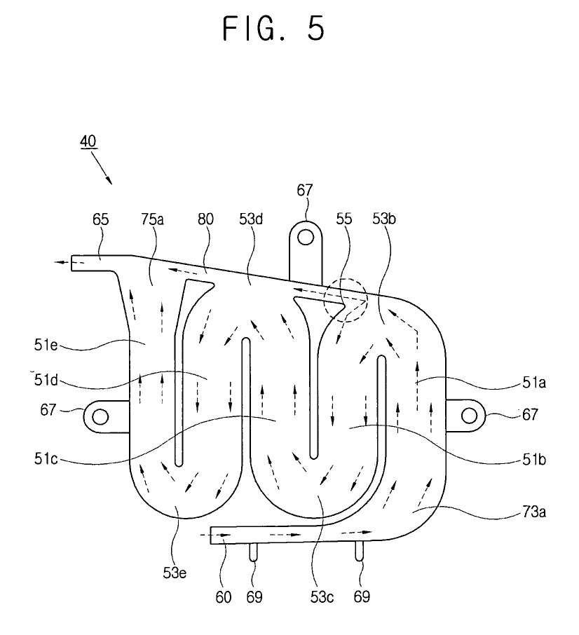

The bypass pipe 80, as shown in FIGS. 2 and 4, communicates with the top end of the zigzag part of the water tank body 50 and the outlet 65. Further, the bypass pipe 80 is disposed to be upwardly inclined to the outlet 65, thereby promptly discharging air generated while supplying water. Further, according to one embodiment, the sectional area of the bypass pipe 80 is gradually reduced going toward the outlet 65. For example, referring to FIG. 4, the diameter of the bypass pipe is gradually reduced from 0.43 X to 0.34 X, wherein X is the width of the water tank body shown in FIG. 3. The reducing proportion of the diameter may be changed according to the width of the water tank body 50, the capacity of the water tank 40, the capacity of the refrigerator and the shape of the section. Thus, the amount of water that is introduced into the bypass pipe 80 at the cross portion 53d in FIG. 5 of the zigzag flow channel and the bypass pipe 80 is gradually decreased, thereby enhancing first-in-fist-out effects. Further, according to one embodiment, the bypass pipe 80 has a cylinder shape to promptly discharge air or the like. But according to another embodiment, the bypass pipe may have various other shapes such as an elliptical shape, and so on.

Here, as shown in FIG. 1, reference numeral 25 indicates a water valve, reference numeral 27 indicates a filter, and reference numeral 29 indicates a water supply pipe, which are not described above.

With the above configuration, the process for supplying water to the water dispenser of the refrigerator 10 will be first described with reference to FIG. 1, and then the process of the flow of water within the water tank 40 will be described with reference to FIG. 5.

First, referring again to FIG. 1, water supplied from a water supply source such as tap water is filtered through the a filter 27 and then is controlled by the water valve 25. The water that passes through the water valve 25 is supplied through water supply pipes 29c and 29a to an ice generating device (not shown) and the water tank 40, respectively. Thus, if a user makes a cup or the like contact the water dispenser 23, the cold water stored within the water tank 40 is discharged through the water supply pipe 29b to the water dispenser 23. Then, the water tank 40 is refilled with the water supplied from the water supply source with the same amount of the water that was discharged from the water tank 40 to the water dispenser 23. Meanwhile, the ice generated from the ice generating device may be supplied from the water dispenser 23.

Next, with reference to FIG. 5, the flow of water within the water tank 40 will be explained hereinafter. First, if the water introduced through the inlet 60 into the lower part of the water tank 40 passes along the first guiding part 73a, vertical part 51a, and reversing part 53b, air and some of water flow along the bypass pipe 80 that is formed in the top end of the reversing part 53b. Most of water is guided along the reversing part 53b to the next vertical part 51b and then flows through the lower reversing part 53c to the vertical part 51c. Then, air that is positioned at the cross portion of the bypass pipe 80 and the reversing part (or cross portion) 53d flows along the bypass pipe 80 disposed at the top end. Meanwhile, at the same portion, the water that flows along the zigzag flow channels 51 and 53 is mixed with the water that flows along the bypass pipe 80, and then the mixed water tends to be introduced into the bypass pipe 80. But since the sectional area of the bypass pipe 80 is gradually reduced toward the outlet 65, the mixing of the water that flows through the zigzag flow channels and the water that flows through the bypass pipe 80 is minimized, thereby maximizing the effects of first in, first out. The water that passes through the reversing part 53d flows through the vertical part 51d, the lower reversing part 53e, the vertical part 51e, and the combining part 75a in turn, and then is supplied through the outlet 65 to the water dispenser 23.

Thus, according to the present invention, since the discharge of air and the like is easily performed, the rest water generated in the water dispenser according to the opening and closing of the water valve may be prevented. Further, the effect of first-in-first-out is maximized in the water tank, whereby the mixing of the water that is cooled in the water tank and the water having normal temperature that is introduced later is minimized and the cooling effect is maximized in order to supply a uniformly cooled drink. Lastly, the volume of the water tank may be optimized by adopting the zigzag shape.

According to the present invention, there is provided a refrigerator having a water tank for preventing the generation of rest water and for easily maximizing the effects of first-in-first-out.

Although a few embodiments of the present invention have been shown and described, the present invention is not limited to the described embodiments. Instead, it will be appreciated by those skilled in the art that changes may be made in these embodiments without departing from the principles and spirit of the invention, the scope of which is defined in the appended claims and their equivalents.

What is claimed is:

1. A refrigerator, which stores water supplied from a water supply source, comprising:
a water tank body comprising an inlet connected with the water supply source, and an outlet communicating with a water dispenser of the refrigerator, and communicating with the inlet through a flow channel; and
a bypass pipe having a bypass flow channel communicating with a top end of the water tank body and the outlet,
wherein a flow channel of the water tank body and the bypass flow channel are branched from each other at 90 degrees or less.

2. The refrigerator according to claim 1, wherein the flow channel of the water tank body is zigzagged upward and downward.

3. The refrigerator according to claim 1, wherein the inlet and the outlet communicate with the lower part of the water tank body and with the upper part of the water tank body, respectively, and are disposed to face each other with respect to the flow channel of the water tank body.

4. The refrigerator according to claim 1, wherein the bypass flow channel is upwardly inclined toward the outlet.

5. The refrigerator according to claim 1, wherein the bypass flow channel has a relatively small cross-sectional area as compared with the flow channel of the water tank body.

6. The refrigerator according to claim 1, wherein the cross-sectional area of the bypass flow channel is gradually reduced going toward the outlet.

7. The refrigerator according to claim 5, wherein the cross-sectional area of the bypass flow channel is gradually reduced going toward the outlet.

8. A refrigerator, comprising:
a water tank that stores water supplied from a water supply source, the water tank comprising
a water tank body having
an inlet connected to the water supply source, the inlet being disposed in a lower part of the water tank body, and
a flow channel that is zigzagged upward and downward,
a bypass pipe having a bypass flow channel that communicates with a top end of the water tank body and is disposed to face flow from the inlet, and
a branching area where water supplied from the water supply source is branched from the zigzag flow channel of the water tank body to the bypass flow channel,
wherein the angle between the zigzag flow channel of the water tank body and the bypass flow channel in the branching area is an acute angle.

9. The refrigerator according to claim 8, wherein the water tank body has an outlet disposed in an upper part thereof to communicate with the water tank body and a water dispenser of the refrigerator.

10. The refrigerator according to claim 9, wherein the inlet and the outlet are disposed on a same lateral side of the water tank body.

11. The refrigerator according to claim 9, wherein the bypass flow channel is upwardly inclined toward the outlet.

12. The refrigerator according to claim 8, wherein the bypass flow channel has a relatively small cross-sectional area as compared with a cross-sectional area of the flow channel of the water tank body.

13. The refrigerator according to claim 8, wherein a cross-sectional area of the bypass flow channel is gradually reduced going toward the outlet.

14. The refrigerator according to claim 12, wherein the cross-sectional area of the bypass flow channel is gradually reduced going toward the outlet.

15. A water tank for a refrigerator, which stores water supplied from a water supply source, the water tank comprising:
a water tank body comprising
an inlet connected with the water supply source, and
an outlet communicating with the inlet through a flow channel that is zigzagged upward and downward and also communicating with a water dispenser of the refrigerator; and
a bypass pipe having a bypass flow channel communicating with a top end of the water tank body and the outlet,
wherein the flow channel of the water tank body and the bypass flow channel are branched from each other at 90 degrees or less.

16. The water tank for the refrigerator according to claim 15, wherein the inlet and the outlet communicate with the lower part of the water tank body and with the upper part of the water tank body, respectively, and are disposed to face each other with respect to the flow channel of the water tank body.

17. The water tank for the refrigerator according to claim 15, wherein the bypass flow channel is upwardly inclined toward the outlet.

18. The water tank for the refrigerator according to claim 15, wherein the bypass flow channel has a relatively small cross-sectional area as compared with the a cross-sectional area of the flow channel of the water tank body.

19. The water tank for the refrigerator according to claim 15, wherein a cross-sectional area of the bypass flow channel is gradually reduced going toward the outlet.

20. A water tank for a refrigerator, which stores water supplied from a water supply source, the water tank comprising:
a water tank body comprising
an inlet disposed at a lower part of the water tank body and connected with the water supply source, and
an outlet disposed at an upper part of the water tank body and communicating with the inlet through a flow channel that is zigzagged upward and downward, and also communicating with a water dispenser of the refrigerator; and
a bypass pipe having a bypass flow channel communicating with a top end of the water tank body and the outlet,
wherein a cross-sectional area of the bypass flow channel is gradually reduced going toward the outlet.

21. A water tank for a refrigerator, which stores water supplied from a water supply source, the water tank comprising:
a water tank body comprising
an inlet disposed at a lower part of the water tank body and connected with the water supply source, and
an outlet disposed at an upper part of the water tank body and communicating with the inlet through a flow channel that is zigzagged upward and downward, and also communicating with a water dispenser of the refrigerator; and
a bypass pipe having a bypass flow channel communicating with a top end of the water tank body and the outlet,
wherein the inlet and the outlet are disposed on a same lateral side of the water tank body.
